(19) United States
(12) Patent Application Publication
(10) Pub. No.: US 2005/0188540 A1
(43) Pub. Date: Sep. 1, 2005

(54) Vibrating razor head

(76) Inventors: Shawn P. Kelly, Ballston Spa, NY (US); Joseph R. Galgana, Marshfield, MA (US)

Correspondence Address: Shawn P. Kelly, 47 Kaatskill Way, Ballston Spa, NY, 12020, US

(21) Appl. No.: 10/786,582

(22) Filed: Feb. 26, 2004

(51) Int. Cl. B26B 19/28

(52) U.S. Cl. 30/45

(57) ABSTRACT

A razor head which uses an ‘active’ material to vibrate each cutting blade. This active material is comprised of either a piezoelectric, electrostrictive, ceramic or ferroelectric type substrate. Each blade will be in mechanical contact with said material and vibrate at a selectable amplitude and frequency. The shaver head is electrically coupled to a housing containing a power source and an electric control module. Alternatively, the battery and the control module can be placed on the razor head itself. In addition, the electronic control module can be on the handle and the active components and battery can be on the razor head. Each of these configurations require no moving parts.

### FIELD OF INVENTION

The invention pertains generally to a vibrating razor and, more particularly, to a razor in which the razor head is adapted for use with a mechanically-responsive material. In which said mechanically-responsive material is excited using an electrical signal.

### BACKGROUND INVENTION

Razors adapted to movably support a blade or a disposable cartridge, commonly referred to as vibrating razors, are well known. Various mechanical arrangements have been devised for causing the rapid movement of the entire razor, a shaving head holding a disposable cartridge, or only a razor blade mounted on or within the razor. Typically, the blade or cartridge is disposed on a support to which movement is imparted.

Early versions of vibrating razors tended to be cumbersome and required external drive sources to impart movement to the blades or blade supports.

One well-known arrangement, herein referred to as the “eccentric weight” type razor, incorporates a weight, which is eccentrically mounted on a rotating shaft such as the shaft of an electric motor. The rapid rotation of the eccentrically mounted weight provides a generally elliptical movement to the entire razor. In this type of razor, the entire razor, including the handle, moves in an elliptical path. It is actually the inability of the person holding the razor to hold the razor still which results in movement of the blade during shaving.

Other types of vibrating razors impart a movement to a disposable cartridge or blade in a direction which is not parallel to the plane of the surface being shaved. An example of this type of vibrating razor is disclosed in U.S. Pat. No. 4,642,892 to Ishida. The Ishida razor drives the cartridge obliquely relative to the blade edge.

Many of the vibrating razors known in the art, including the “eccentric weight” type razors, do not impart movement directly to the blade or cartridge support. In such razors, the blade or cartridge is not positively or directly driven by the electric motor. Another example of a vibrating razor which does not directly impart movement to the cartridge support is shown in U.S. Pat. No. 4,819,330 to Fenn, et al. The Fenn razor comprises a hollow shaver head resiliently mounted on a handle. The hollow shaver head has a pivotally mounted weight disposed therein which is driven by an electric motor. When the motor is energized and the weight is caused to oscillate within the hollow shaver head, the shaver head rocks relative to the handle due to the inertia imparted by the oscillating weight. The shaver head of the Fenn patent is not directly driven by the electric motor and, therefore, could remain still relative to the handle while the electric motor continues to drive the pivotally mounted weight.

It would, therefore, be desirable to provide a self-contained vibrating razor wherein a piezoelectric actuator directly imparts movement to a blade.

### SUMMARY OF INVENTION

An electric razor comprising of a piezoelectric, electrostrictive, ceramic or ferroelectric film substrate. A battery for powering said piezoelectric, electrostrictive, ceramic or ferroelectric film type substrate. A handle which encases an electronic control module and battery wherein said handle has a longitudinal axis. An electric razor head comprising of a piezoelectric, electrostrictive, ceramic or ferroelectric film substrate. A battery for powering said piezoelectric, electrostrictive, ceramic, or ferroelectric film type substrate, an electronic control module all of which are collocated on the razor head itself. Both these configurations provide a means for vibrating the cutting blades without the use of moving parts.

The present invention is directed to a razor and, more particularly, to a razor head which will vibrate the cutting blades without the use of moving parts. Present vibrating razors known in the art tend to be cumbersome and require external drive sources to impart movement to the cutting blades. The methods used to vibrate the cutting blades use moving parts. These moving parts take many forms, such as; motors, eccentric weights, rotating shafts, gears, etc. . . . Moving parts cause vibrations to be translated throughout the razor assembly. These vibrations make the shaving difficult and annoying. The vibrations imparted to the users hand and arm does not aid in the hair removal process. It would therefore be desirable to provide a self-contained vibrating razor head wherein the cutting blades were vibrated without the aid of moving parts. Minimal vibrations will be felt by the user's hands due to vibrating the cutting blades only. The present invention is directed to a vibrating razor which provides movement to the cutting blades only. In accordance with the present invention, a piezoelectric, electrostrictive, ceramic or ferroelectric material is applied to the cutting blades. The cutting blades are vibrated electrically. An electronic control module will generate the driving signal. The electronic control module and/or battery can be positioned on the handle and/or razor head itself. The driving signal can be adjusted to suit the user's needs. The control assembly and power supply are housed within the handle of the razor. Alternatively, the control module and battery can exist on the razor head alone. This arrangement will not require an electrical connection between the handle and razor head.

### BRIEF DESCRIPTION OF DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 is a photograph which illustrates a razor head with a mechanically-responsive material attached to the cutting blades.

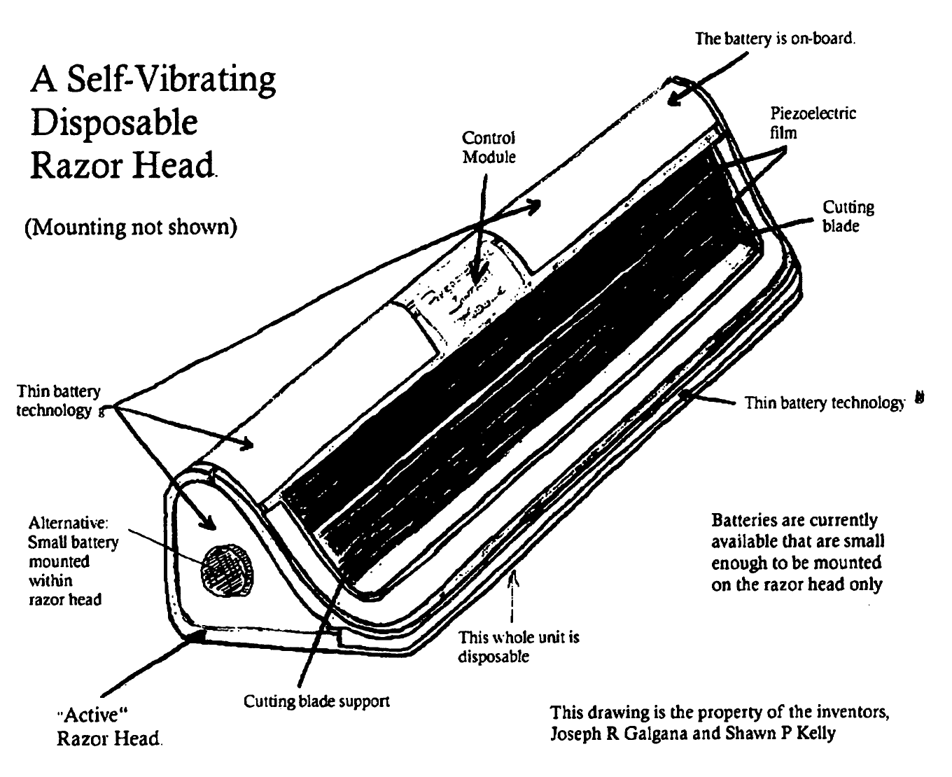

1. An electric vibrating razor comprising:
a piezoelectric, electrostrictive, ceramic or ferroelectric material substrate;
a battery for powering said piezoelectric, electrostrictive, ceramic or ferroelectric material substrate;
a handle which encases an electronic control module and said battery wherein said handle has a longitudinal axis;
a solid shaver head pivotally and electrically attached to said handle wherein said shaver head has a piezoelectric, electrostrictive, ceramic or ferroelectric material substrate applied to one or several cutting blade;
a means for electrically coupling said shaver head to said electronic control module.

2. An electric vibrating razor according to claim 1 wherein said coupling means is an electrical union.

3. An electric vibrating razor according to claim 2 wherein said electrical union is a female coupling disposed at the distal end of said handle.

4. An electric vibrating razor according to claim 2 wherein said electrical union is a male coupling protruding from said shaver head.

5. An electric vibrating razor according to claim 2 wherein said electrical union is contained within the pivotal head and said handle at their connection point.

6. An electric vibrating razor according to claim 2 wherein said electrical union is housed in plastic.

7. An electric vibrating razor according to claim 3 wherein said female coupling is housed in plastic and contains two cylindrical metal sleeves about 0.125 inches in length.

8. An electric vibrating razor according to claim 4 wherein said male coupling is housed in plastic and has two protruding metal prongs of longitudinal axis about 0.125 inches in length.

9. An electric vibrating razor according to claim 1 further comprising a seal disposed between said shaver head and said handle.

10. An electric vibrating razor according to claim 2 wherein said electrical union supplies power to said shaver head.

11. An electric vibrating razor according to claim 2 wherein said electrical union is integrated into the mechanical coupling of the shaver head and said handle mentioned in claim 1.

12. An electric vibrating razor according to claim 1 wherein said battery is rechargeable.

13. An electric vibrating razor according to claim 1 wherein said battery is replaceable.

14. An electric vibrating razor according to claim 1 wherein said electronic control module is powered by a battery.

15. An electric vibrating razor according to claim 14 wherein said electronic control module generates a signal variable in frequency and amplitude to said shaver head cutting blades.

16. An electric vibrating razor according to claim 14 wherein said electronic control module is housed within the said handle.

17. An electric vibrating razor according to claim 14 wherein said electronic control module transmits power to said cutting blades electrically via said electrical union mentioned in claim 2.

18. An electric vibrating razor according to claim 14 wherein said electronic control module is comprised of solid state circuitry.

19. An electric vibrating razor according to claim 14 wherein said electronic control module is sealed within said handle.

20. An electric vibrating razor according to claim 14 wherein said electronic control module is comprised of circuitry used to generate signals of varying frequency and amplitude.

21. An electric vibrating razor according to claim 1 wherein said shaver head cutting blades are in mechanical contact with a piezoelectric, electrostrictive, ceramic or ferroelectric material substrate.

22. An electric vibrating razor according to claim 21 wherein said cutting blades are electrically connected to the said electrical union mentioned in claim 2.

23. An electric vibrating razor according to claim 21 wherein said cutting blades are stimulated electrically and vibrated mechanically via said piezoelectric, electrostrictive, or ceramic or ferroelectric material substrate mentioned in claim 1.

24. An electric vibrating razor according to claim 21 wherein said cutting blades are housed within said shaver head.

25. An electric vibrating razor according to claim 21 wherein said cutting blades are made of metal and in mechanical contact with said piezoelectric, electrostrictive, ceramic or ferroelectric material substrate mentioned in claim 1.

26. An electric vibrating razor according to claim 21 wherein said cutting blades will vibrate at a selectable frequency and amplitude.

27. An electric vibrating razor according to claim 21 wherein said cutting blades are electrically connected to said handle.

28. An electric vibrating razor according to claim 21 wherein said cutting blades are electrically connected to said male coupling mentioned in claim 4.

29. A vibrating razor comprising:
a power source;
a shaver head cutting blades with piezoelectric, electrostrictive, ceramic or ferroelectric material substrate attached thereto;
an electronic control module;
means for housing said power source and said electronic control module;
means for electrically coupling a shaver head and handle;
means for mechanically coupling a shaver head and handle with an electrical connection within;
means for electrically coupling said handle and shaver head cutting blades which allows each cutting blade to vibrate at a selectable frequency and amplitude.

30. A vibrating razor according to claim 29 wherein said coupling means comprises an electrical connection.

31. A vibrating razor according to claim 29 wherein said electrical coupling means imparts vibrations to said shaving head cutting blades.

32. A vibrating razor according to claim 29 wherein said electrical coupling provides the driving force for each cutting blade.

33. A vibrating razor according to claim 29 wherein said electrical connection is completely housed within a rigid mechanical connection.

34. A vibrating razor according to claim 29 wherein said electrical coupling is achieved by mating two metals.

35. An electric vibrating razor according to claim 29 wherein said electronic control module is powered by any source.

36. An electric vibrating razor according to claim 29 wherein said electronic control module generates a signal variable in frequency and amplitude to said shaver head cutting blades and this setting is savable.

37. An electric vibrating razor according to claim 29 wherein said electronic control module is mounted to the said handle.

38. An electric vibrating razor according to claim 29 wherein said electronic control module transmits power to said cutting blades electrically via a conducting median.

39. An electric vibrating razor according to claim 29 wherein said electronic control module integrated into the handle using semiconductor layering technology.

40. An electric vibrating razor according to claim 29 wherein said shaver head cutting blades are powered and controlled on the shaver head itself.
